(19) United States
(12) Patent Application Publication
(10) Pub. No.: US 2018/0274118 A1
(43) Pub. Date: Sep. 27, 2018

(54) Method of Electroplating Conductor and Joints Thereof

(71) Applicant: ABB Schweiz AG, Baden (CH)

(72) Inventors: Sheng Zhong, Hillsborough, NC (US); Ghanshyam Shrestha, Cary, NC (US); Darren Dale Tremelling, Apex, NC (US)

(21) Appl. No.: 15/466,007

(22) Filed: Mar. 22, 2017

(51) Int. Cl. C25D 7/00; H02K 15/04; H02K 15/03; C25D 5/02; C25D 3/38; C25D 5/50

(52) U.S. Cl. CPC C25D 7/00; H02K 15/04; C25D 5/50; C25D 5/022; C25D 3/38; H02K 15/03

(57) ABSTRACT

A method includes providing a conductor with a joint and a solution. In accordance with a step of the method, the conductor with the joint is inserted into the solution for a time sufficient to deposit a sufficient amount of conductive material in the joint to allow current to flow through the joint at a desired level when the conductor is installed in an application. In accordance with another aspect of the method, a structure with a joint is inserted into the solution for a time sufficient to deposit a sufficient amount of conductive material in the joint to strengthen the joint to a desired level. In accordance with another step of the method, an electromotive force is applied between an anode and the conductor for electolytic formation of the joint. In another aspect of the invention, the solution is configured for electroless formation of the joint.

### FIELD OF THE DISCLOSURE

This disclosure relates to methods of electrical machine and equipment manufacturing, especially to conductor fabrication for such machinery.

### BACKGROUND

Electrical conductors, including bar conductors, are widely used in electrical equipment. Usually, conducting wires have a uniform cross section and have substantial length. However, there are often many joints in the conductor wires, for instance, between coils of wound conductors, in the end regions of formed copper rotor windings on induction motors, between stator coils of form wound machines, as well as in synchronous machines with flattened field windings. The end connections or joints of these conductors are ordinarily joined by brazing, hot welding or soldering operations. More in particular, for the fabrication of end rings of electrical machines, brazing is commonly used to mechanically and electrically connect each bar to the ring. The ring may be specially machined according to the frame size and pole number of the machine as well as speed and starting characteristics. For fabrication of field windings of large synchronous machines, soldering is used to connect each winding segment to the adjacent segment. Each segment has a given thickness, length and width according to the placement in the machine. In the automotive industry, tungsten gas welding is often used to connect hairpin coils. This welding technique involves significant heat, and may be limited in connection density.

Forming these joints is often difficult, costly, and time and labor intensive. The heat from the brazing, welding, or soldering operations may damage adjacent temperature sensitive components, especially the typical polymeric insulation used on the various conductors being connected.

### SUMMARY

This disclosure describes a method using electrolytic/electroless plating to join the bar conductors as well as to make conductors. In this process the conductor ends are atomically connected by the metal deposited through plating. The many choices of chemistries allow one to meet requirements of the material and specific processes. The plating procedure allows for joints with high precision and quality, and allows mass production, effectively reducing the cost of producing the joints and therefore the machine. The processes described herein allow for the fabrication of complete conductor windings, as well as a rotor.

### DESCRIPTION OF DRAWINGS

FIG. 1 shows a schematic diagram of a method of forming a joint joining two conductors by inserting the conductors and the joint in a plating solution.

FIG. 2 shows a schematic diagram of a method of forming joints joining rotor bars and an end ring by inserting the end ring and rotor bars in a plating solution.

FIG. 3 shows a flat winding typically found as a field winding in a synchronous machine.

FIG. 4 shows a schematic diagram of a method of forming a joint in a flattened field winding of the type shown in FIG. 3 by inserting the winding in a plating solution.

FIG. 5 shows the formation of the joint in the field winding after insertion in the plating solution as shown in FIG. 4.

FIG. 6 is an enlarged view of the joint of the field winding taken from detail area 6-6 of FIG. 5.

FIG. 7 shows an exemplary insulating structure in a coil form prior to plating.

FIG. 8 shows a schematic diagram of a method of forming a complete conductor winding by inserting the insulating structure of FIG. 7 in a plating solution.

FIG. 9 shows the formation of a complete conductor winding after insertion in the plating solution as shown in FIG. 8 with the conductor winding having plating on one helical surface.

FIG. 10 shows an alternate configuration of the formation of a complete conductor winding after insertion in the plating solution as shown in FIG. 8 with the conductor winding having plating on both helical surfaces.

FIG. 11 shows a schematic representation of plating applied to a rotor of an electrical machine.

FIG. 12 shows a schematic representation of plated bands on a surface of a rotor of an electrical machine.

### DETAILED DESCRIPTION

Referring to the drawings, there is shown a method of using electrolytic metal plating to fabricate conductors as well as to reinforce and strengthen joints between conductors. The methods shown herein may also be used in connection with electroless metal plating by omitting the anode and the supply of electromotive force, and preparing the plating solution accordingly. By way of example and not in any limiting sense, to facilitate the discussion that follows, the drawings and description show methods using copper electrolytic metal plating, although other plating methods, plating solutions, anodes, and materials may also be used.

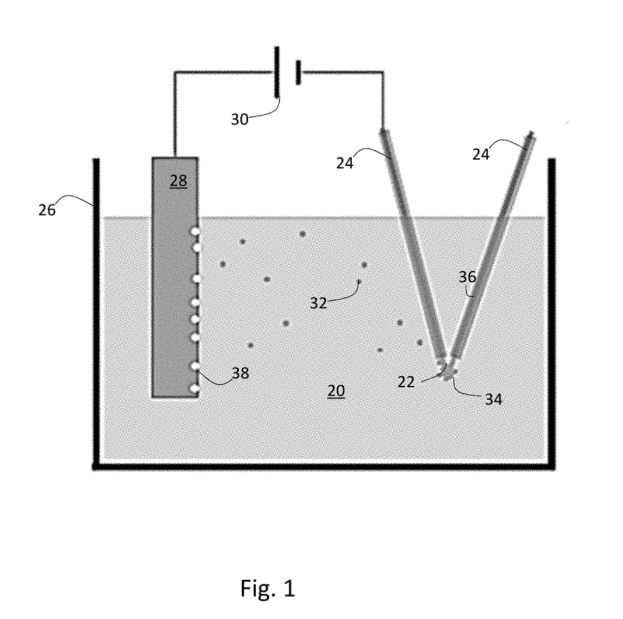

FIG. 1 shows a schematic diagram of a method of using an electrolytic plating solution 20 for the fabrication of a joint 22 joining two conductors 24. The electrolytic plating solution 20 may be contained in a container 26 of sufficient depth to allow insertion of the conductor assembly into the volume and to allow formation of the joint 22 joining the conductors 24. The container 26 may be of sufficient size to allow insertion of the anode 28 in the volume. A voltage or current source 30 to provide electromotive force may be connected between the anode 28 and at least one of the conductors 24 with the conductor functioning as a cathode. The source of electromotive force 30 may be a direct current (DC) power supply. The power supply may also be AC power supply, pulse power supply, or other forms as are known in the art. The conductors 24, e.g., the cathode, may be connected to the negative side of the DC power supply and the anode 28 may be connected to the positive side of the DC power supply. As current flows from the source of electromotive force 30 through the anode 28 and the solution 20 to the conductors 24 (e.g., cathode), a material 32 in the electrolytic plating solution, e.g., metallic ions in a salt compound, may comprise a conductive material 34 to be deposited in the joint 22 joining the conductors 24. The solution 20 may contain a salt compound containing a material 32 which is the same as the conductive material 34 to be deposited in the joint 22. The conductors 24 may be masked with insulation material 36, so as to expose the location where the joint 22 is to be formed. The insulation 36 masking the conductors may be a material sufficiently corrosion resistant to withstand the plating solution 20. The conductors 24 may be arranged so that the majority of the conductive material 34 deposited in the joint 22 will be concentrated in regions of interest in forming the joint. Regions of interest may be selectively formed on the conductors by masking regions that are not desired to be plated and/or by inserting only those areas to receive the conductive material into the plating solution. The conductors 24 may be in physical contact or in close proximity.

During plating with the DC power source 30 supplying current to the anode 28, the material 38 comprising the anode, e.g., the metal ions comprising the anode, may be dissolved into the plating solution 20. The material 38 comprising the anode may then be transported to the conductors 24 (e.g., the cathode), and more in particular, the joint 22 between the two conductors 24, where it is deposited as the conductive material 34 to form the joint. The material 38 forming the anode may be the same as the conductive material 34 deposited in the joint or may be different.

The thickness and area of coverage of the joint may be controlled by accumulated charges and plating area. In electroless plating, the anode and source of electromotive force may be omitted and a catalyst may be provided in the solution 20 to begin the plating process and the deposition of the conductive material 34 in the joint 22 joining the conductors 24. By inserting multiple conductors in the plating solution, for instance, in parallel with the source of electromotive force, each having its own power supply, or without a power supply and anode, multiple joints may be formed simultaneously. In another example, multiple joints may be formed using a single power source, which may, in addition to the aforementioned sources, include a battery. The distribution of the anode and numerous cathodes may be arranged in such a way that the rate of deposition of the conductive material at each joint is substantially the same. In a similar way, many parts may be processed, and similar or different operations completed. This may lead to improved manufacturing efficiency.

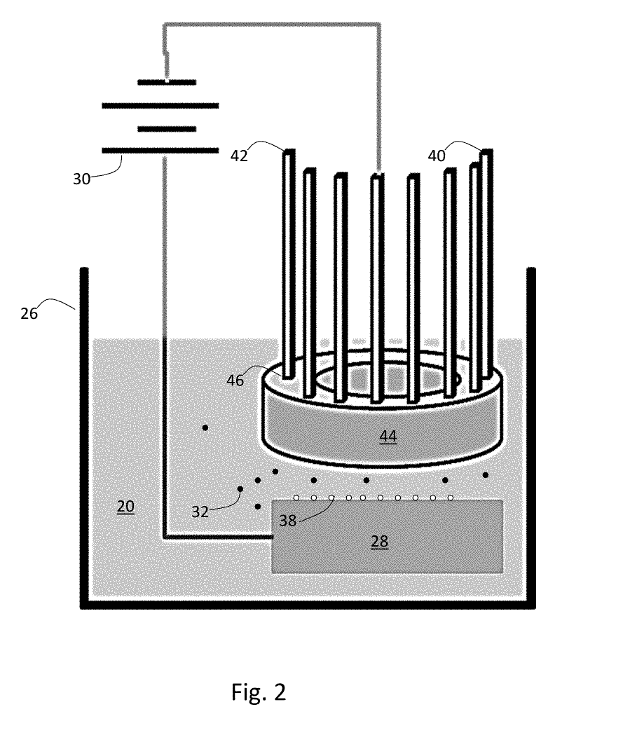

FIG. 2 provides another example of a method where electrolytic metal plating is used with a structure 40, for example, conductor bars 42 to an end ring 44. An electroless process may also be used by omitting the anode and the power supply and configuring the plating solution accordingly. While the structure shown includes portions of a rotor for an induction motor, other structures may be processed in a similar way, for instance, a printed circuit board with conductors, transformer windings, stator windings, segments of windings, etc. The exemplary structure 40 comprising the rotor bars 42 and the end ring 40 may be inserted into the plating solution 20 to a depth in the solution where the joints 46 (e.g., the connections between the bars and the end ring) are to be formed and/or strengthened. The rotor bars 42 and/or the end ring 44 may be joined to the negative side of a source of electromotive force 30, e.g., a DC power source. The rotor bars 42 and/or the end ring 44 may be arranged as the cathode. An anode 28 may be inserted into the plating solution 20 and connected to the positive side of the source of the electromotive force 30. Depending upon the time of insertion and plating, the amount of conductive material deposited to form the joints 46 between the bars 42 and the end ring 44 may be set for a desired conductivity or strength based on dimensional change. Also, depending upon the time of insertion and plating, the dimensional size (diameter and thickness) of the end ring 44 can be controlled as desired. Thus, the end ring 44 may be finished through the plating process while the joints 46 between the rotor bars 42 and end ring 44 are formed and/or strengthened. In this example, similar to the first example, a mask may be placed on the conductors in regions that are not intended to have plating reinforcement. Exemplary regions may include the axial ends, as well as the inner and outer diameter surfaces of the end ring. While the drawings show an end ring and bar interface used for a typical induction motor, the geometry of the end ring and the bars and their respective interface may vary depending on the application. In another example, multiple processes for connecting the conductors may be used to form the joints. For example, the bars may be attached to the ring or a printed circuit board (PCB) via soldering, and the assembly may be processed through an electrolytic/electroless plating process as described herein to deposit conductive material at areas of interest, for instance, the soldered joints, to enhance the joint's electric or/and mechanical properties. The plating methods described herein allow for a high connection density between the end ring and the conductor bars as the localized deposition of the conductive material at the interface more effectively accumulates in the spaces between the end ring and the conductor bars when compared to soldering or welding methods.

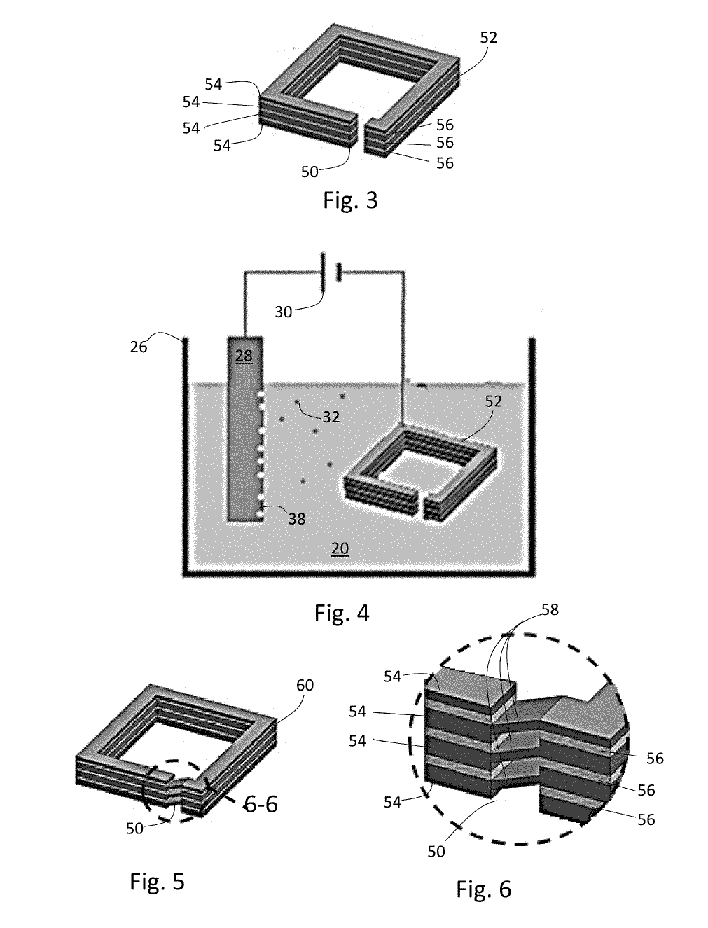

FIGS. 3-6 provide an illustration of a method of electrolytic metal plating to form joints 50 in a stack 52 of semi-finished, winding sections 54. The method may also prove to be useful for forming joints in flat field windings or hairpin winding connections. As shown in FIG. 3, each winding section 54 of the semi-finished stack 52 may be placed on an insulator sheet 56. Then, as shown in FIG. 4, the arrangement of semi-finished stack 52 of winding segments 54 may be inserted in the plating solution 20 to form the joints 50 between adjacently stacked winding sections 54. As shown in FIG. 4, the semi-finished stack 52 is arranged as a cathode in the manner similar to that described previously in relation to FIGS. 1 and 2. The material 38 in the anode 28 and the material 32 in the plating solution 20 may be deposited as conductive material 58 in each joint 50 to form a completed wound stack 60 as shown in FIGS. 5 and 6. Because the temperatures involved in the plating operation are generally low, the plating operation provides little adverse effect on the insulation sheet 56 and other masking material. The insulating material 56 and other masking material may be provided to permit the conductive material 58 to be deposited in the joints 50 to form the joint in a preferential manner, for instance, the inclined ramp arrangement shown in FIGS. 5 and 6. Thus, the layers of the winding segments 54 may be connected simultaneously with the pattern of the resultant conductive material 58 deposition in the joints 50, for instance, as shown in FIGS. 5 and 6. In one example, the wound connectors have a thickness of 4.5 mm. A plating solution of copper ions generally can create 1 mm of thickness of copper in a time period of about 1½ hours to 3½ hours. This would allow all the connectors to be made in a range of about 6½ hours to about 16 hours. This represents the potential to save manufacturing time, manpower, and cost.

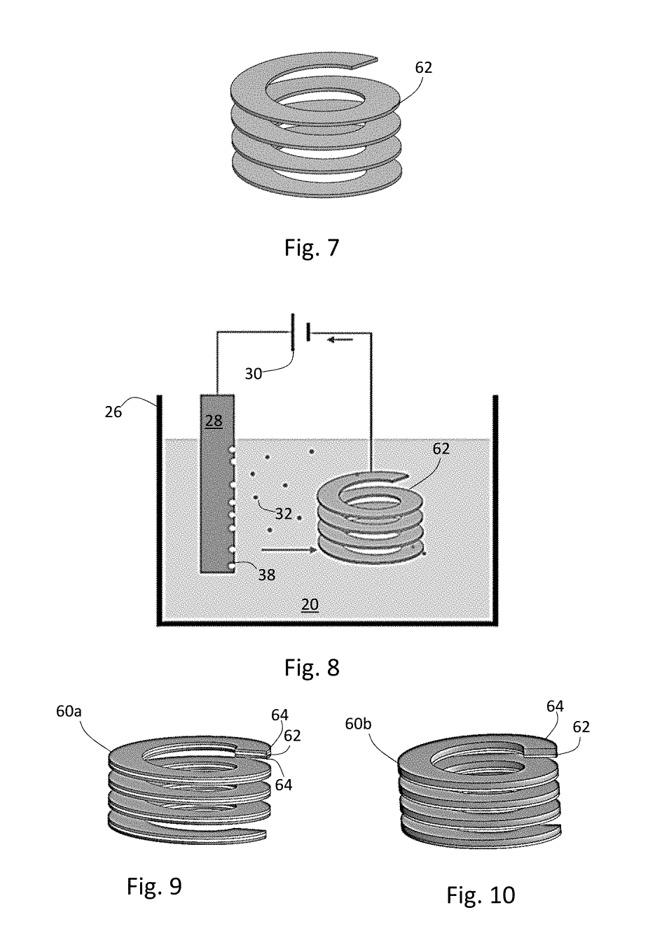

In a further example, as shown in FIGS. 7-10, a complete layered field winding (FIG. 9, ‘60a’; FIG. 10 ‘60b’) may be formed using electrolytic/electroless plating. An insulating material or substrate 62 may be formed into the desired shape for the field winding, for instance, the helical winding geometry shown in FIG. 7. The insulating material or substrate 62 may be twisted, molded, potted or extruded to form the desired geometric structure. The surface(s) of the insulating material or substrate 62 desired to be plated may be activated. For instance, to produce the field winding 60a shown in FIG. 9, an upper surface of the helical insulating substrate or material may be activated, or to produce the field winding 60b shown in FIG. 10, both upper and lower surfaces of the helical insulating substrate or material 62 may be activated. The insulating substrate or material 62 may be electro-conductively activated for electrolytic plating or catalytically activated for electroless plating. The activated insulating substrate 62 will be immersed into the plating solution 20 for plating, for instance, the electrolytic plating process, as shown in FIG. 8. In the case of electroless plating, the power source 30 and anode 28 shown in FIG. 8 are not needed. The conductive material 64 may be deposited on the activated surfaces of the insulating substrate or material 62. One side (FIG. 9) or both sides (FIG. 10) of the insulating substrate may be plated with conductive material 64 with a constant or varying thickness of conductive material deposited in the areas to be plated, as well as a combination of varying dimensions. The variations in dimensions of the conductive material 64 may be achieved via a continuous plating process or in a repeated or stepped manner. The final geometry of the field winding 60a,60b may be determined by the shape of insulating substrate or material 62 and the activated surface. The material composition of the conductive material 64 may be determined by the plating chemistry, for instance, the material in the plating solution, and as the case may be, the material of the anode. The amount of conductive material 64 deposited on the insulating substrate or material 62 (i.e., its thickness) may be determined by the current density and plating time. The aforementioned process allows for a completed field winding to be produced in one step which eliminates the conventional process of stacking bar conductors in a layered arrangement and connecting the adjacent layers through welding to form a helical coil structure. The conventional process is labor intensive and costly, especially as the axial length of the coil increases with additional stacked layers. As shown in FIGS. 7-10, a complete layered field winding may be manufactured via electrolytic/electroless plating in one step, which may be automated and configured to produce multiple field winding systems in a single plating process, thus reducing labor and material cost.

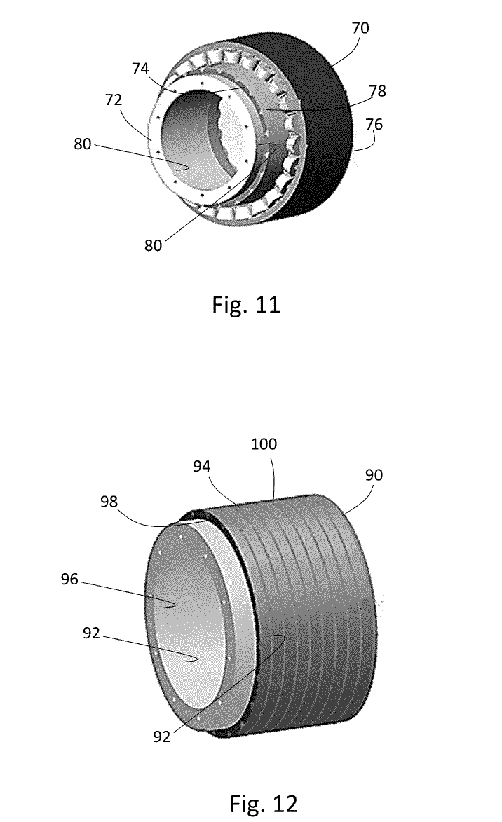

The plating techniques described herein may be used for reinforcing and strengthening components of an electrical machine 70, for instance, as shown in FIG. 11, which depicts components of a permanent magnet motor including a rotor 72 with surface mounted magnets 74 disposed in the bore of a stator 76. An element of the rotor or the rotor itself may be processed through an electrolytic/electroless plating procedure as described below. By way of example, the magnets 74 of the rotor 72 may be embedded in a base material 78 to provide an optimal air gap between the stator 76 and rotor 72. The base material 78 may be a ceramic or polymeric material and may be electro-conductively activated for electrolytic plating or catalytically activated for electroless plating. Using a electrolytic or electroless plating method as described previously, a magnetic permeable material or conductive material 80 may be plated radially inward from the rotor outer diameter (i.e., in a direction away from air gap of machine) to form the rotor and rotor back-iron. Thus, the magnetically permeable or conductive material 80 forming the back-iron and mechanical structure may be formed without the use of casting, punching, or other traditional turning or other subtractive machining methods. By forming the base material 78 with location surfaces, shoulders, recesses, and other features, into which the magnets 74 may be placed prior to plating, various mechanical interface features such as bearing interfaces, and shaft flanges may be formed or constructed during the plating process, thereby eliminating multiple parts and interfaces between parts. By using the plating process described herein, the labor required to machine the back-iron and the flange, and to insert the surface magnets on the rotor may be significantly reduced. This process may also improve yields in terms of the amount of material utilized to manufacture the rotor. The thickness of the plated structures may be maintained as small as desired, with the overall thickness required for a particular application being a function of the diameter and the number of poles of the machine. By way of example, a thinner back-iron layer may be used with smaller diameter machines and with machines having a higher number of poles. Rotors having a back-iron thickness under 10 mm may be particularly suited for the processes described herein. While the foregoing description involved plating being applied to the radially inward facing and radially inward arranged surfaces and structures of the rotor, the radially outward facing and outwardly arranged surfaces and structures of the rotor may also be plated. For instance, plating may be applied on the air gap side of the magnets. Such plating material may have sufficient mechanical strength to reinforce the bonds of the magnets to the base material. The plating material may be conductive and/or substantially non-magnetically permeable or magnetically permeable depending upon the application.

FIG. 12 provides a further illustration of a rotor 90 of an electrical machine after processing to deposit conductive material 92 on the radially outward facing and outwardly arranged surfaces and structures and the radially inward facing and radially inward arranged surfaces and structures of the rotor. The conductive and/or magnetically permeable material 92 may be deposited on the outer diameter surface 94 of the rotor 90 as well the rotor bore 96 for attachment of a shaft structure at the inner diameter. The material 92 plated on the outer diameter surface 94 may encase surface magnets 98 to enable the rotor 90 to withstand the centrifugal forces generated during high speed rotation of the rotor which might otherwise cause the magnets to detach from the rotor. The material 92 plated on the outer diameter surface 94 may be contiguous along the axial length of the rotor 90 or may be of thin axial bands with gaps 100 formed therebetween in order to reduce the eddy current losses. The gaps 100 between axial adjacent bands may be formed by arranging insulating layers in an axially spaced arrangement on the rotor surface before plating is initiated. The insulating layers may comprise the base material 78 described in relation to FIG. 11. The material 92 plated on the rotor outer diameter surface 94 may be as thin as 0.1 mm and as thick as few millimeters, with larger thicknesses being used for larger diameters and speeds. The width of the bands of the conductive material 92 plated on the rotor outer diameter surface 94 may also vary from sub millimeter to a couple of millimeters.

The methods described herein allow for multiple conductors and/or joints to be formed simultaneously. Additionally, multiple parts and/or structures may be processed at the same time. For instance, several different parts each requiring plating operations may be simultaneously processed in the solution tank. Each may have its own power supply so as to allow independent control of voltage and time for plating. This would allow the processing of multiple parts at the same time regardless of whether the parts are the same. Processing using electrolytic or electroless plating may be largely automated thereby resulting in reduced manpower, manufacturing costs and lead time. A wide variety of metallic materials may be used, including without limitation, copper, ferrite, nickel, cobalt, silver, gold, aluminum, chromium, lead, zinc, magnesium, and various alloys including these elements. Non-metallic elements may also be used, including but not limited to phosphorous, boron, chloride, sulfate and oxygen. Because the efficiency of the deposition of the conductive material in the joint is high, the incremental material and energy costs may be generally low. Tooling for the processing is very minimal and easy to manufacture and maintain. Electrolytic and/or electroless plating generally uses less energy than brazing, soldering, or welding operations. Additionally, because the operation temperatures are generally low, there is low risk for thermal damage to insulation. The plating operations may be performed with external power sources (electrolytic) or without external power sources (electroless). The finished plated materials may be treated to attain a desired crystal structure. This may provide for enhanced mechanical and electrical properties of the joint and the conductive material deposited in the joint. The post treatments may include heat treatment or degassing.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A method comprising:
providing a conductor for an electric motor, the conductor being formed with a joint;
providing a solution; and
inserting the conductor with the joint into the solution for a time sufficient to deposit a sufficient amount of conductive material in the joint to allow current to flow through the joint at a desired level when the conductor is installed in the motor and to increase a strength of the joint.

2. The method of claim 1 wherein the step of providing the conductor with the joint includes masking the conductor except in an area of the joint.

3. The method of claim 2 wherein the masking includes providing an insulator for the conductor.

4. The method of claim 3 wherein the step of inserting the conductor into the solution includes inserting the joint with the masking into the solution.

5. The method of claim 1 wherein the step of providing the solution includes providing a material in the solution that is the same as the conductive material to be deposited in the joint.

6. The method of claim 1 further comprising providing a source of electromotive force and an anode having a material the same as the conductive material to be deposited in the joint.

7. (canceled)

8. A method comprising:
providing an insulating substrate,
forming the insulating substrate into a selected geometry for use as a field winding for a stator of an electric motor;
providing a solution;
inserting the insulating substrate into the solution for a time sufficient to deposit a sufficient amount of conductive material onto the insulating substrate to form the field winding with sufficient conductive material to allow current to flow through the field winding at a desired level when the field winding is installed in the stator of the motor.

9. The method of claim 8 wherein the step of providing the insulating substrate includes masking the insulating substrate except in areas where conductive material is to be deposited.

10. The method of claim 8 wherein the step of providing the insulating substrate includes activating the insulating substrate in areas where conductive material is to be deposited.

11. (canceled)

12. The method of claim 8 wherein the step of providing the solution includes providing a material in the solution that is the same as the conductive material to be deposited on the insulating substrate.

13.-14. (canceled)

15. The method of claim 8 wherein the step of providing the solution includes providing a compound comprising at least one of the following copper, iron, cobalt, nickel, zinc, silver, gold, aluminum, chromium, phosphorous, lead, zinc, magnesium, boron, sulfate and oxygen.

16. The method of claim 8 further comprising post-plating heat treatment of the field winding.

17. A method comprising:
providing an electric motor with a plurality of conductors and a printed circuit board, and a joint extending between the respective conductor and the printed circuit board,
providing a solution;
inserting the conductors with the respective joint into the solution for a time sufficient to deposit a sufficient amount of conductive material in the joint to allow current to flow through the joint at a desired level when the conductor is installed in the motor and to increase a strength of the joint between the conductor and the printed circuit board to a desired level when the conductor is installed the motor.

18. The method of claim 17 wherein the step of providing the electric motor with the plurality of conductors includes masking the conductors except in an area of the joint.

19. The method of claim 17 wherein the step of inserting the structure into the solution includes inserting the joint with the masking into the solution.

20. The method of claim 17 wherein the step of providing the solution includes providing a material in the solution that is the same as the conductive material to be deposited in the joint.

21. The method of claim 17 further comprising providing a source of electromotive force and an anode having a material the same as the conductive material to be deposited in the joint.

22. (canceled)

23. The method of claim 1 wherein the step of providing the solution includes providing a compound comprising at least one of the following copper, iron, cobalt, nickel, zinc, silver, gold, aluminum, chromium, phosphorous, lead, zinc, magnesium, boron, sulfate and oxygen.

24. The method of claim 17 wherein the step of providing the solution includes providing a compound comprising at least one of the following copper, iron, cobalt, nickel, zinc, silver, gold, aluminum, chromium, phosphorous, lead, zinc, magnesium, boron, sulfate and oxygen.
